(19) United States
(12) Patent Application Publication
(10) Pub. No.: US 2025/0270878 A1
(43) Pub. Date: Aug. 28, 2025

(54) LADDER

(71) Applicant: iKamper Co., Ltd., Paju-si, Gyeonggi-do (KR)

(72) Inventors: Jae Hyung YUN, Paju-si, Gyeonggi-do (KR); Soon Kyu PARK, Paju-si, Gyeonggi-do (KR)

(21) Appl. No.: 18/727,963

(22) PCT Filed: May 20, 2024
(86) PCT No.: PCT/KR2024/006785

§ 371 Date: Jul. 10, 2024

(30) Foreign Application Priority Data
Nov. 6, 2023 (KR) 10-2023-0151529
Feb. 27, 2024 (KR) 10-2024-0027706

(51) Int. Cl. E06C 1/393; E06C 1/12; E06C 7/08; E06C 7/16; E06C 7/50

(52) U.S. Cl. CPC E06C 1/393; E06C 1/125; E06C 7/08; E06C 7/16; E06C 7/50

(57) ABSTRACT

Disclosed is a ladder capable of improving portability by reducing volume when not in use and preventing a user from slipping. The ladder according to the present disclosure comprises a pair of vertical frames, a plurality of horizontal frames installed between the pair of vertical frames at predetermined intervals, and a step sheet configured to be coupled to any two horizontal frames among the plurality of horizontal frames, respectively, to form a footrest of a ladder, and the step sheet may be detachably coupled to the horizontal frame through a coupling means.

### TECHNICAL FIELD

The present disclosure relates to a ladder, and more particularly, to a ladder including a safety footrest for preventing a user from slipping.

### BACKGROUND ART

In general, ladders are auxiliary means of transportation used to go up or down high places, allowing users to move easily and quickly between various types of facilities with floor height differences.

However, in the case of a typical ladder, there is a problem that the user frequently misses the vertical support held by the hand or slips and falls from the horizontal support while moving to the desired position while repeatedly holding the vertical support with the hand and stepping on the horizontal support with the foot.

Therefore, it is an aspect of the disclosure to provide a guard member mounted on a horizontal support of a ladder to prevent a safety accident of a user.

However, in the case of the ladder described above, a plurality of fixing members having a Velcro method, or a buckle method are used to attach the guard member to the horizontal support of the ladder. In this case, not only the working time for attaching the guard member to the ladder is considerable, but also the fixing members are loosened as the user uses the ladder and thus are eliminated from the ladder. Moreover, since the ladder described above has a method in which a plurality of fixing members are attached to the rear surface of the integrated guard member, the entire guard member may have to be purchased again when a part of the guard member is damaged.

Meanwhile, conventional ladders generally maintain a constant length, and thus have a problem that they are inconvenient to carry due to their large volume. Therefore, there is also a need for a ladder capable of reducing the volume while being carried and moved.

### CITATION LIST

(Patent Literature 1) Korean Patent No. 10-2228108 (Mar. 16, 2021)

### SUMMARY OF INVENTION

### Technical Problem

An object of the present disclosure for solving the above-described problem is to provide a ladder with improved portability by reducing the volume when not in use.

Another object of the present disclosure for solving is to provide a ladder, which is capable of preventing a user from slipping.

Another object of the present disclosure for solving is to provide a ladder capable of facilitating replacement when a part of the ladder is damaged by using the ladder.

### Solution to Problem

To achieve the foregoing objectives, the ladder according to one embodiment of the present disclosure comprises a pair of vertical frames, a plurality of horizontal frames installed between the pair of vertical frames at predetermined intervals, and a step sheet configured to be coupled to any two horizontal frames among the plurality of horizontal frames, respectively, to form a footrest of a ladder, and the step sheet may be detachably coupled to the horizontal frame through a coupling means.

The coupling means comprises a plurality of screws coupled through the horizontal frame and the step sheet.

The coupling means further comprises a reinforcing plate installed between the head of the screw and the step sheet when the screw is coupled through the horizontal frame and the step sheet.

The coupling means comprises a plurality of magnetic bodies coupled to each other by magnetism, and the plurality of magnetic bodies are disposed on one side of the horizontal frame and one side of the step sheet corresponding to the one side of the horizontal frame.

The coupling means comprises a sliding groove formed on one side of the horizontal frame and a pole member formed on one side of the step sheet and coupled by sliding in the sliding groove.

A plurality of magnetic bodies coupled to each other by magnetism are provided at predetermined positions of the sliding groove and the pole member.

Each of the magnetic bodies is disposed at both ends of the sliding groove and at both ends of the pole member, respectively, to prevent the pole member from being separated after the pole member is coupled to the sliding groove.

A plurality of magnetic bodies having different polarities are installed inside the sliding groove, wherein each of the magnetic bodies having a first polarity is provided at both ends of the sliding groove, respectively, wherein a plurality of magnetic bodies having a second polarity different from the first polarity are disposed between the magnetic bodies having the first polarity, wherein each of the magnetic bodies having the second polarity is disposed at both ends of the pole member, respectively, and when the pole member is coupled by sliding in the sliding groove, a magnetic body having a second polarity of the sliding groove and a magnetic body having a second polarity of the pole member exert repulsive force on each other in the sliding groove, thereby improving mobility of the pole member, and at both ends of the sliding groove, a magnetic body having a first polarity of the sliding groove and a magnetic body having a second polarity of the pole member exert an attractive force on each other to prevent the pole member from being separated from each other.

The coupling means comprises a sliding groove formed in an upper portion and a lower portion of the horizontal frame, respectively and a plurality of coupling members formed on both sides of the step sheet and coupled by sliding in the sliding groove, and the coupling member comprises a fixing hole inserted into the sliding groove through both ends of the sliding groove and configured to slide and move along the sliding groove, a coupling hole coupled to one side of the step sheet, and a connecting hole connecting the fixing hole and the coupling hole.

A plurality of magnetic bodies having magnetism are provided at a predetermined position inside the sliding groove, wherein the fixing hole is provided with a magnetic body coupled each other by magnetism to the magnetic body installed in the sliding groove. thereby when the fixing hole is positioned at a predetermined position where the magnetic body of the sliding groove is installed, being prevented from being separated by magnetism.

### Advantageous Effects of Invention

According to the ladder according to an embodiment of the present disclosure, the volume may be reduced when not in use, thereby improving portability.

According to the ladder according to an embodiment of the present disclosure, it is possible to prevent a user from slipping when using the ladder by including a step sheet as a step assistant.

According to the ladder according to an embodiment of the disclosure, when some of the step sheets are damaged, it is possible to replace the damaged step sheet without having to replace all of the plurality of step sheets.

According to the ladder according to an embodiment of the present disclosure, the user can easily replace the step assist unit directly, thereby increasing manufacturing convenience and ease of use.

Meanwhile, the effects of the disclosure are not limited to the above-mentioned effects, and various effects may be included within a range obvious to those skilled in the art from what will be described below.

### BRIEF DESCRIPTION OF DRAWINGS

FIG. 1 is a perspective view illustrating a state in which a ladder is extended in a height direction in a state in which the step sheet is not installed on the ladder according to the present disclosure.

FIG. 2 is a perspective view illustrating an overlapping state of a ladder by moving in a direction opposite to a height direction in a state in which a step sheet is not installed on the ladder according to the present disclosure.

FIG. 3 is a perspective view illustrating a state in which a ladder is extended in a height direction in a state in which the step sheet is installed on the ladder according to the present disclosure.

FIGS. 4 to 6 are drawings illustrating an embodiment of connecting a step sheet and a horizontal frame according to the present disclosure.

FIG. 7 is a drawing illustrating another embodiment of connecting a step sheet and a horizontal frame according to the present disclosure.

FIGS. 8 to 11 are drawings illustrating another embodiment of connecting a step sheet and a horizontal frame according to the present disclosure.

FIG. 12 is a drawing illustrating other embodiments of a sliding groove formed in a horizontal frame according to the present disclosure.

FIGS. 13 to 15 are drawings illustrating another embodiment of connecting a step sheet and a horizontal frame according to the present disclosure.

FIGS. 16 and 17 are drawings illustrating another embodiment of connecting a step sheet and a horizontal frame according to the present disclosure.

FIG. 18 is a step sheet according to an embodiment of the present disclosure.

FIGS. 19 and 20 are drawings illustrating a cover member according to an embodiment of the present disclosure.

### DESCRIPTION OF EMBODIMENTS

Hereinafter, some embodiments of the disclosure will be described in detail with reference to exemplary drawings. In adding reference numerals to components of each drawing, it should be noted that the same components are denoted by the same reference numerals as possible, even if they are shown in different drawings.

In describing embodiments of the disclosure, a detailed description of known configurations or functions related thereto will be omitted if it is determined that the detailed description interferes with understanding of the embodiments of the disclosure.

In describing the components according to the embodiments of the disclosure, terms such as first, second, A, B, (a), (b), and the like may be used. These terms are only for distinguishing a component from other components, and the nature, order, or order of the component is not limited by the terms.

The singular forms “a,” “an,” and “the” include plural forms unless the context clearly dictates otherwise. As used herein, the terms “comprise” and/or “include” do not exclude the presence or addition of one or more other components other than the above-mentioned components.

In the accompanying drawings, the X direction refers to a direction from the ladder toward the user, the Y direction refers to a longitudinal direction in which the horizontal frame 100 is formed, and the Z direction refers to a direction toward the height of the ladder.

Hereinafter, the disclosure will be described in more detail with reference to the accompanying drawings.

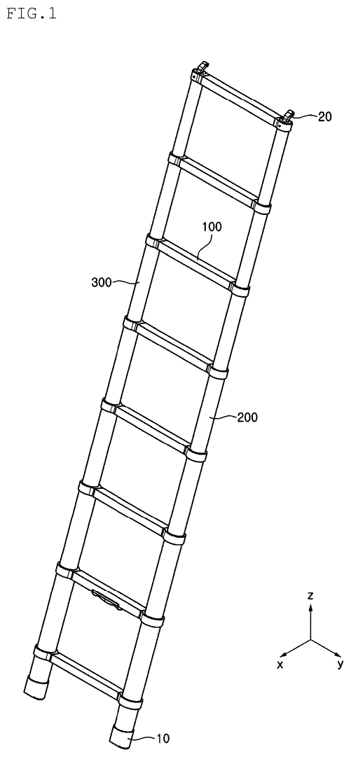

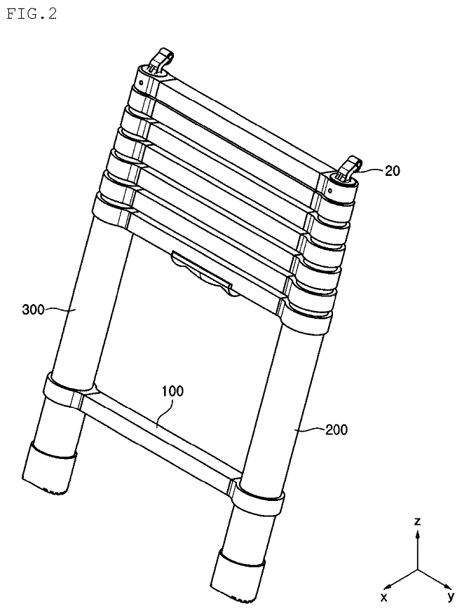

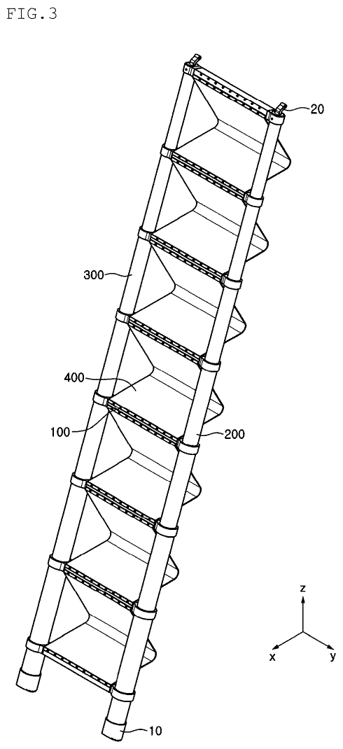

FIG. 1 is a perspective view illustrating a state in which a ladder is stretched in a height direction in a state in which a step sheet 400 is not installed on the ladder according to the disclosure, and FIG. 2 is a perspective view illustrating a state in which a ladder is moved in a direction opposite to the height direction and is overlapped in a state in which a step sheet 400 is not installed on the ladder according to the disclosure. FIG. 3 is a perspective view illustrating a state in which a step sheet 400 is installed on a ladder according to the present disclosure and the ladder is extended in a height direction.

Referring to FIGS. 1 and 3, a ladder according to the disclosure includes a pair of vertical frames 200 and 300, a plurality of horizontal frames 100, and a step sheet 400.

The pair of vertical frames 200 and 300 include a right vertical frame 200 and a left vertical frame 300. The pair of vertical frames 200 and 300 may include an internal space therein, and a plurality of hollow pipes having different diameters may be continuously connected to overlap each other. In this case, each hollow pipe and the lower hollow pipe connected thereto may be individually inserted so that the plurality of hollow pipes are overlapped each other and stacked inside. However, when the ladder is inserted individually, a plurality of insertion operations may be required when the total length of the ladder is minimized. In the present disclosure, a single protruding clip installed under the lowest horizontal frame may be used to enhance convenience. Specifically, when the corresponding single protruding clip is pressed, each hollow pipe may be configured to be inserted into the lower hollow pipe connected thereto in a domino manner. The method of implementing the domino method is not limited, and it would be sufficient for those of ordinary skill in the art to configure adjacent horizontal frames to be stacked on each other at once.

Each of the pair of vertical frames 200 and 300 may be made of a light and strong material as an embodiment. Each of the pair of vertical frames 200 and 300 is formed of a plurality of hollow pipes having different diameters. For example, the hollow pipe forming the lowest end of each of the vertical frames 200 and 300 may have the largest diameter. Other hollow pipes overlap and are inserted into the largest diameter hollow pipe forming the lowest end, and the upper ends are pulled out one after another and connected continuously to reduce or increase their length. In this case, each hollow pipe may be positioned inside so that the overlapping hollow pipe does not exceed the length of the hollow pipe into which it is inserted. A support portion 10 in contact with the bottom surface is formed at the lower end of the vertical frames 200 and 300, and the support portion 10 is made of rubber or synthetic resin material having a large coefficient of friction so that it does not slip easily when the ladder is leaned.

A hanging unit 20 with a hook-shape may be formed on the upper ends of the vertical frames 200 and 300 to hang a ladder at a specific point.

Both sides of the plurality of horizontal frames 100 are fixed to each of the plurality of hollow pipes positioned corresponding to each other, and are installed between the pair of vertical frames 200 and 300 at predetermined intervals. An uneven pattern may be formed on the upper surfaces of the plurality of horizontal frames 100 to prevent the user from slipping.

In at least one horizontal frame 100 among the plurality of horizontal frames 100, a fixing means (not shown) may be installed to fix the hollow pipes to respective positions in a state in which the pair of vertical frames 200 and 300 are stretched and unfolded in the height direction (z-axis direction) to prevent the hollow pipes from overlapping and stacking inward. The fixing means may include a locking pin (not shown) installed to be movable toward the vertical frames 200 and 300 inside the horizontal frame 100, and a lever (not shown) for moving the locking pin.

The locking pin reciprocates at the connection points of the horizontal frame 100 and the vertical frames 200 and 300 by the operation of the lever. When the locking pin moves from the horizontal frame 100 toward the vertical frames 200 and 300, the movement of the hollow pipe is prevented to prevent the vertical frames 200 and 300 from being stretched or overlapped and stacked inside. The lever may protrude outward from one side of the horizontal frame 100 and may be disposed at an appropriate position according to user convenience. For example, the lever may be disposed to protrude from the lower surface of the horizontal frame 100, or may be disposed to protrude from one side of the horizontal frame 100 toward the user. The user may freely move the hollow pipe fixed at the predetermined position by retracting the locking pin by pressing the lever, thereby adjusting the length of the ladder.

The step sheet 400 is coupled to any two horizontal frames 100 of the plurality of horizontal frames 100, respectively, to form a footrest of a ladder together with the horizontal frame 100. Specifically, the step sheet 400 is coupled to two horizontal frames 100 adjacent to each other at both ends to form a footrest of a ladder. The step sheet 400 prevents the user using the ladder from slipping. The step sheet 400 may be coupled to the horizontal frame 100 so as to be easily released. The step sheet 400 is coupled to be easily released from the horizontal frame 100 through a plurality of coupling means included in various embodiments, so that when some of the step sheets 400 are damaged, only the damaged step sheet 400 may be replaced without having to replace all of the plurality of step sheets 400, and the user may easily replace the step sheet 400 directly.

The step sheet 400 may be made of a flexible material. For example, the step sheet 400 may be made of cloth or a synthetic material (cotton, nylon, or polyester). In some examples, the step sheet 400 may be made of a light and strong material (e.g., lip stop nylon fabric, cube fiber, or polyethylene). The step sheet 400 may be coupled to two horizontal frames 100 adjacent to each other and then bent at a predetermined angle near the center.

A reflective plate (not shown) formed in a thin band shape may be additionally attached to at least one end of the step sheet 400 along the one end thereof. It is preferable that the reflector is made of a fluorescent material capable of generating light even in dark places, but a material in which the reflector is visible even in dark places is sufficient and is not limited to a fluorescent material. Even if a ladder is used in a dark environment due to the reflector, the risk of the user stepping on the ladder may be reduced.

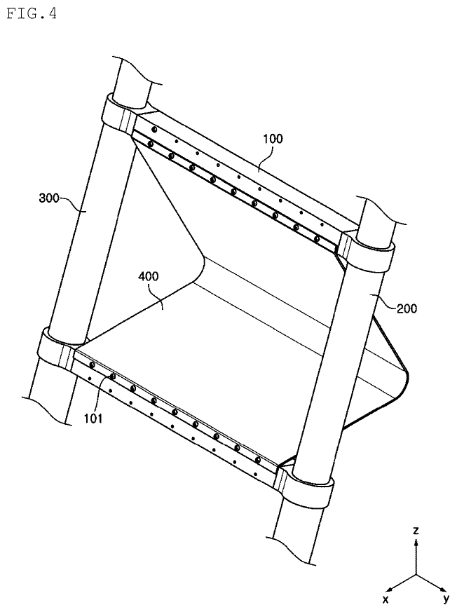

FIGS. 4 to 6 are drawings illustrating an embodiment of being coupled between a step sheet 400 and a horizontal frame 100 according to the present disclosure.

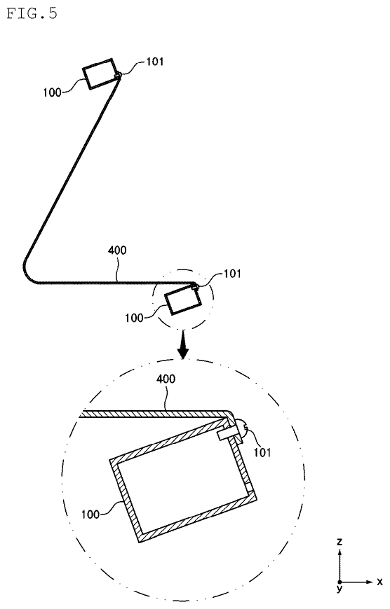

Referring to FIGS. 4 to 5, the step sheet 400 and the horizontal frame 100 according to the present disclosure are coupled to be released through a coupling means including a plurality of screws 101. In this case, the plurality of screws 101 are coupled through the horizontal frame 100 and the step sheet 400, respectively. The plurality of screws 101 may be coupled to one side of the horizontal frame 100 in a direction (x-axis direction) toward the user, respectively. Each of the plurality of screws 101 couples one end of the step sheet 400 to one side of the horizontal frame 100. The plurality of screws 101 may couple the step sheet 400 and the horizontal frame 100 to each other on one side surface of the horizontal frame 100 toward the user. When any step sheet 400 among the plurality of step sheets 400 is damaged, the user may release the screws 101 of the horizontal frame 100 to which the step sheet 400 is coupled, and then replace the screws 101 with the new step sheet 400.

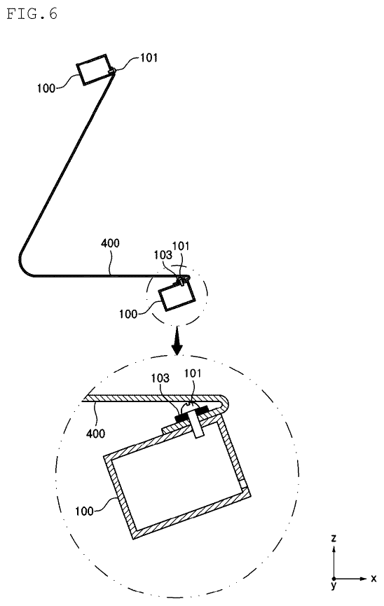

Referring to FIG. 6, the coupling means for coupling the step sheet 400 and the horizontal frame 100 according to the disclosure may further include a reinforcing plate 103 installed between the head of the screw 101 and the step sheet 400 when the screw 101 is coupled through the horizontal frame 100 and the step sheet 400. A coupling strength between the screw 101 and the horizontal frame 100 may be further increased by the reinforcing plate 103, and thus a coupling strength between the step sheet 400 and the horizontal frame 100 may be further increased.

In this case, as illustrated in FIG. 6, the reinforcing plate 103 may be included only in the horizontal frame 100 located relatively below, but is not limited thereto, and may also be installed in the horizontal frame 100 located above according to an embodiment. In addition, the positions where the plurality of screws 101 included in the coupling means are coupled to the horizontal frame 100 include not only one side surface of the horizontal frame 100 toward the user as illustrated in FIG. 5, but also an upper end surface of the horizontal frame 100 as illustrated in FIG. 6. In addition, the step sheet 400 and the horizontal frame 100 may be coupled to each other through a plurality of screws 101 on one side surface of the horizontal frame 100 toward the user and an upper end surface of the horizontal frame 100, respectively.

FIG. 7 is a drawing illustrating another embodiment of being coupled between a step sheet 400 and a horizontal frame 100 according to the present disclosure.

As illustrated in FIG. 7, the coupling means for detachably connecting the horizontal frame (100) and the step sheet (400) may include a pair of magnetic bodies (105, 107) respectively arranged at corresponding positions. As illustrated in FIG. 7, the pair of magnetic bodies 105 and 107 may be coupled to one side surface of the horizontal frame 100 toward the user to couple the step sheet 400 to the horizontal frame 100. A plurality of magnetic bodies 105 and 107 may be coupled to one side surface of the horizontal frame 100 by being spaced apart from one side surface of the horizontal frame 100 by a predetermined interval.

In the pair of magnetic bodies 105 and 107, magnetic bodies 105 and 107 having different polarities may be installed in the horizontal frame 100 and the step sheet 400, respectively. That is, the plurality of magnetic bodies 105 and 107 may be disposed on one side of the horizontal frame 100 and one side of the step sheet 400 corresponding to one side of the horizontal frame 100. However, the present disclosure is not limited thereto, and a magnetic body 105 may be installed on one side of the step sheet 400 as described above, and a metal body 107 capable of exerting an attractive force with the magnetic body 105 may be installed on one side of the horizontal frame 100 to magnetically couple the step sheet 400 and the horizontal frame 100.

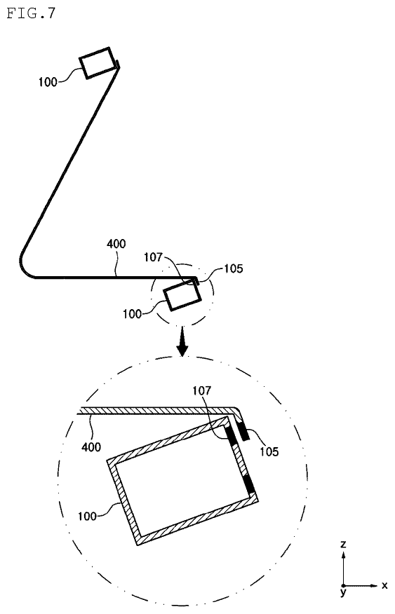

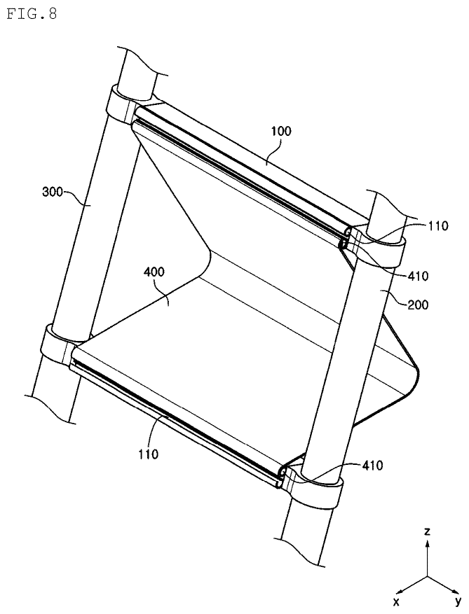

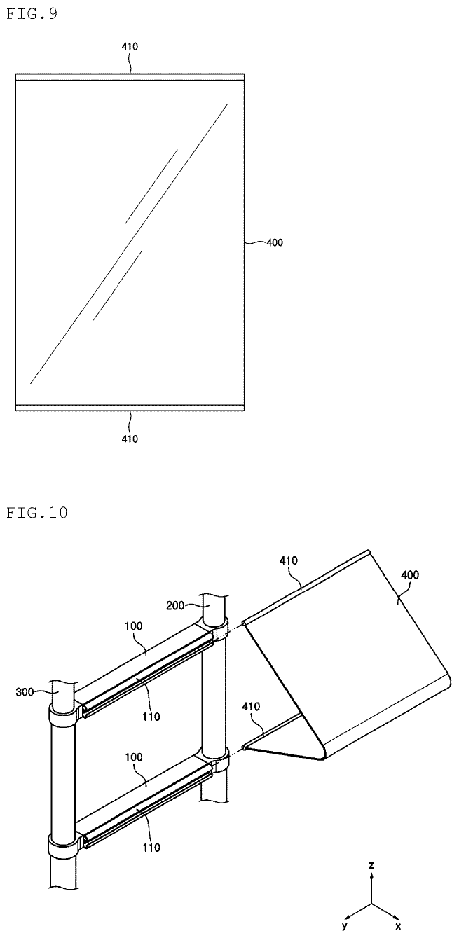

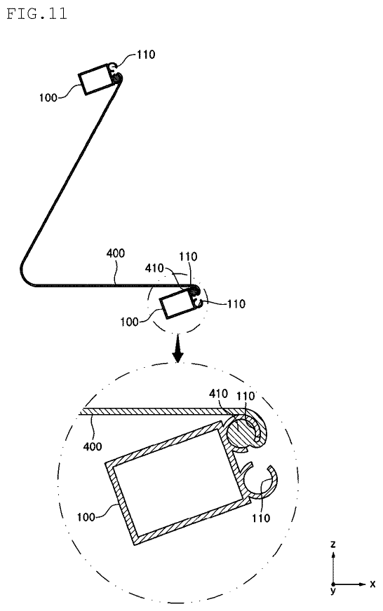

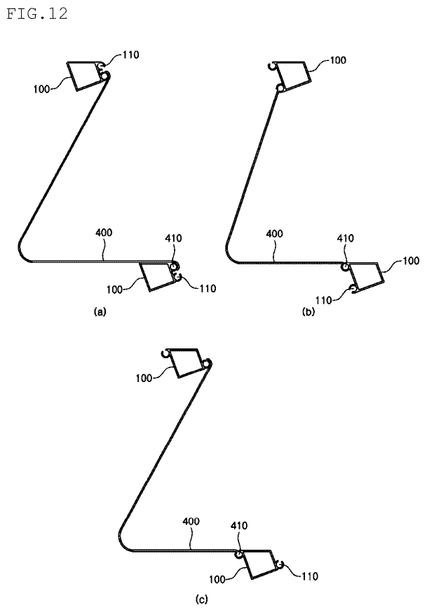

FIGS. 8 to 11 are drawings illustrating another embodiment of being coupled between the step sheet 400 and the horizontal frame 100 according to the present disclosure. FIG. 12 is a drawing illustrating other embodiments of the sliding groove 110 formed in the horizontal frame 100 according to the present disclosure.

Referring to FIGS. 8 to 11, the coupling means for detachably coupling the step sheet 400 and the horizontal frame 100 each other according to the present disclosure includes a sliding groove 110 and a pole member 410. The sliding groove 110 is formed on one side of the horizontal frame 100.

The pole member 410 is formed on both sides of the step sheet 400, specifically at one end and the other end in the height direction, respectively. The pole member 410 formed at one end of the step sheet 400 and the pole member 410 formed at the other end may be coupled to the sliding groove 110 formed at one side of any horizontal frame 100 and the sliding groove 110 formed at another side of the horizontal frame 100, respectively.

The pole member 410 may have a solid columnar shape and may have a shape surrounded by one end of the step sheet 400. The outer diameter of the pole member 410 may be formed to be somewhat smaller than the inner diameter of the sliding groove 110. The pole member 410 may be inserted into the sliding groove 110 and then slide inside the sliding groove 110 to move in the longitudinal direction (y-axis direction) of the horizontal frame 100. One end of the pole member 410 may be inserted into one end of the sliding groove 110 and then moved in the longitudinal direction of the horizontal frame 100 inside the sliding groove 110.

The sliding groove 110 may be formed on one side of the horizontal frame 100, and the sliding groove 110 may be formed to share coupling between the horizontal frame 100 and the step sheet 400 located relatively below, and the sliding groove 110 may be formed to share coupling between the step sheet 400 and the horizontal frame 100 located relatively above. That is, a pair of sliding grooves 110 may be formed on one side of the horizontal frame 100.

However, the disclosure is not limited thereto, and the sliding grooves 110 formed in the horizontal frame 100 may be arranged in various ways. As illustrated in FIG. 12(a), a pair of sliding grooves 110 may be formed on one side facing the user, or as illustrated in FIG. 12(b), a pair of sliding grooves 110 may be formed on one side opposite to the direction facing the user. Alternatively, as illustrated in FIG. 12(c), one sliding groove 110 may be formed on one side facing the user, and the other sliding groove 110 may be formed on one side opposite to the direction facing the user.

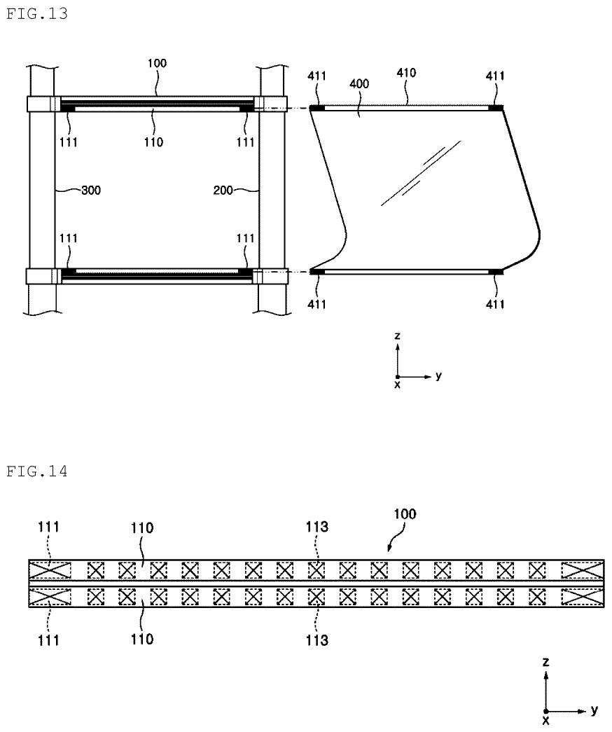

FIGS. 13 to 15 are drawings illustrating another embodiment of being coupled between the step sheet 400 and the horizontal frame 100 according to the present disclosure.

Referring to FIG. 13, as an embodiment of the coupling means according to the disclosure, a plurality of magnetic bodies 111 and 411 coupled to each other by magnetism may be installed at predetermined positions of the sliding groove 110 and the pole member 410. Specifically, the plurality of magnetic bodies 111 and 411 may be installed at both ends of the sliding groove 110 and both ends of the pole member 410, respectively. As one end of the pole member 410 is inserted into the sliding groove 110 and then slides along the sliding groove 110 to move in a direction opposite to the sliding groove 110, when the pole member 410 is located at an appropriate predetermined position, the magnetic bodies 411 installed at both ends of the pole member 410 and the magnetic bodies 111 installed at both ends of the sliding groove 110, respectively, may exert an attractive force to each other by magnetism to prevent the pole member 410 from being separated. That is, the magnetic bodies 111 installed at both ends of the sliding groove 110 exert an attractive force with the magnetic bodies 411 installed at both ends of the pole member 410, respectively, to prevent the step sheet 400 from moving from the correct position by the user's use. When the step sheet 400 is separated from the correct position, the user may step out despite the presence of the step sheet 400. The movement of the pole member 410, more specifically, the step sheet 400 is prevented by the magnetic bodies 111 and 411 installed in the sliding groove 110 and the pole member 410. The magnetic bodies 111 and 411 installed in the sliding groove 110 and the pole member 410 function as stoppers to prevent the step sheet 400 from moving.

Referring to FIG. 14, as another embodiment of the coupling means according to the disclosure, a plurality of magnetic bodies 111 and 113 having different polarities may be installed inside the sliding groove 110. For example, when the magnetic bodies 111 disposed at both ends of the sliding groove 110 respectively have the first polarity, a plurality of magnetic bodies 113 having the second polarity may be disposed between the magnetic bodies 111 having the first polarity of the sliding groove 110. Here, the second polarity means a polarity opposite to the first polarity. For example, when the first polarity is the N pole, the second polarity may be the S pole, and when the first polarity is the S pole, the second polarity may be the N pole.

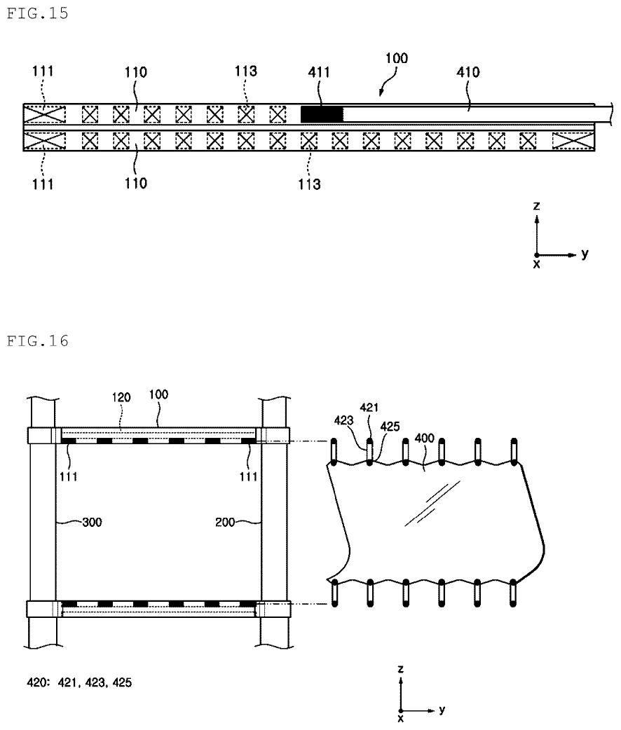

A magnetic body 411 having a second polarity is disposed at both ends of the pole member 410, and as described with reference to FIG. 13, when both ends of the pole member 410 are located at both ends of the sliding groove 110, the pole member 410 is prevented from moving by the attractive force of each of the magnetic bodies 111 and 411. Meanwhile, as the plurality of magnetic bodies 113 of the second polarity are installed between the magnetic bodies 111 of the first polarity of the sliding groove 110, when the pole member 410 is inserted into the sliding groove 110 and then slidably coupled to each other, referring to FIG. 15, the magnetic bodies 113 of the second polarity of the sliding groove 110 and the magnetic bodies 411 of the second polarity of the pole member 410 may exert repulsive force on each other in the sliding groove 110, thereby further improving the mobility of the pole member 410 within the sliding groove 110. Therefore, as the magnetic body 113 installed inside the sliding groove 110 and the magnetic bodies 411 installed at both ends of the pole member 410 have the same polarity, the pole member 410, more specifically, the step sheet 400, may be moved and coupled more easily.

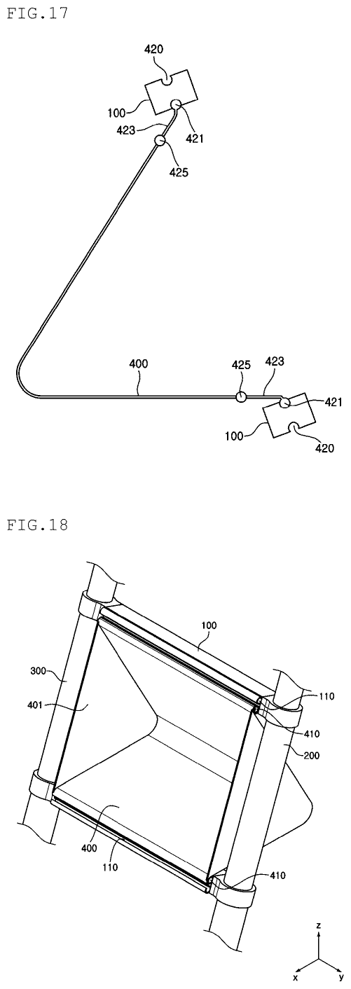

FIGS. 16 and 17 are drawings illustrating another embodiment of being coupled between a step sheet 400 and a horizontal frame 100 according to the present disclosure.

Referring to FIGS. 16 and 17, a coupling means configured to be detachably coupled between the step sheet 400 and the horizontal frame 100 may include a sliding groove 110 formed in an upper portion and a lower portion of the horizontal frame 100, respectively, and a coupling member 420 formed on both sides of the step sheet 400. The coupling member 420 is inserted into the sliding groove 110 and then coupled by sliding along the inside of the sliding groove 110. A plurality of coupling members 420 are installed at both ends of the step sheet 400.

The coupling member 420 includes a fixing hole 421, a coupling hole 425, and a connecting hole 423. The fixing hole 421 is inserted into the sliding groove 110 through both ends of the sliding groove 110 and slides and moves along the sliding groove 110. A plurality of coupling holes 425 are coupled to both sides of the step sheet 400, respectively. The connecting hole 423 connects the fixing hole 421 and the coupling hole 425.

Each of the plurality of fixing holes 421 may be inserted into the sliding groove 110 and then moved so that the step sheet 400 may be detachably coupled between the horizontal frames 100. According to an embodiment, as the plurality of separate fixing holes 421 are inserted into and fastened to the sliding groove 110, the step sheet 400 may be coupled to the horizontal frame 100 more easily than the coupling through the pole member 410 described above.

In this case, a plurality of magnetic bodies 111 may be installed in the sliding groove 110. In this case, each of the plurality of magnetic bodies 111 may be installed at a predetermined position where the fixing hole 421 is to be located. In addition, each fixing hole 421 may include a magnetic body configured to exert an attractive force to correspond to the magnetic body 111 installed in the sliding groove 110. Alternatively, the fixing hole 421 itself may be formed of a magnetic body 421.

Therefore, when the fixing holes 421 respectively corresponding to the predetermined positions at which the magnetic bodies 111 of the sliding groove 110 are installed are located, the fixing holes 421 may be prevented from being separated from the predetermined positions by attractive force of the magnetic bodies 111 and 421, that is, by magnetism.

FIG. 18 is an embodiment of a step sheet 400 according to the present disclosure.

As an embodiment, the step sheet 400 may further include side portions 401 that close both side surfaces. According to an embodiment, the side portion 401 may be further included to prevent the user's foot from falling into the side surface of the ladder. The side portion 401 may be formed of the same material as the step sheet 400, and may be formed of a more flexible polymer material than the step sheet 400, so that the shape of the side portion 401 may be easily changed even when the plurality of hollow pipes in the vertical frame overlap each other.

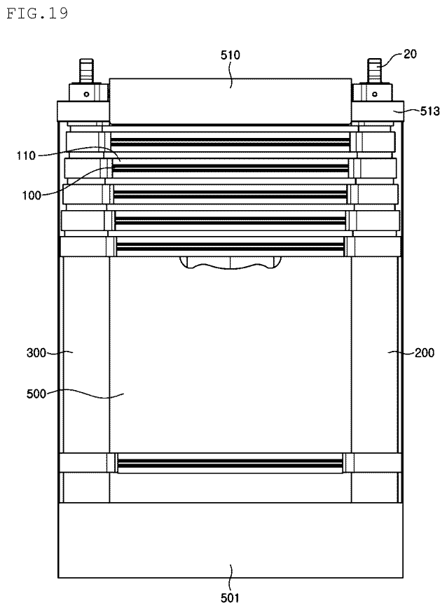

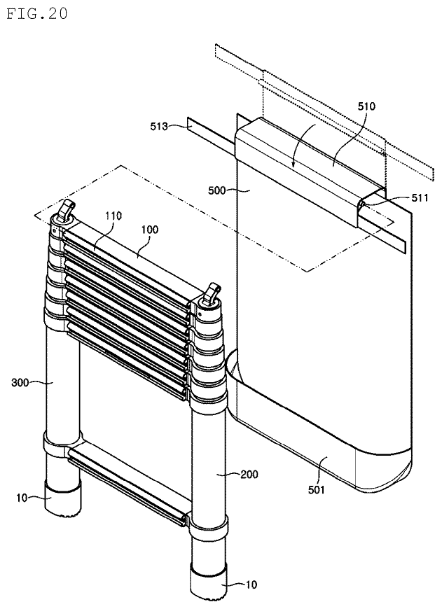

FIGS. 19 and 20 are drawings illustrating a cover member according to the present disclosure.

The ladder according to the present disclosure can improve portability by reducing the volume when not in use. Referring to FIG. 19, the outside of the ladder may be protected by the cover member 500 in a state in which the hollow pipes of the vertical frames 200 and 300 of the ladder are overlapped and stacked inside each other. As an embodiment, the cover member 500 may cover the upper portion, the rear portion, and the lower portion of the ladder in the overlapping state. The upper portion 510 of the cover member is coupled to the upper portion of the ladder, and the lower portion 501 of the cover member is located outside the support portion 10 of the ladder to protect the support portion 10. The upper portion 510 of the cover member may further include a fixing means 513 such as Velcro for being coupled to the upper portion of the ladder and then surrounding and fixing the upper portion of the ladder.

The material of the cover member is not particularly limited, and may be a flexible material or a non-flexible plastic material. In the case of a flexible material, when the ladder is unfolded and used, the cover member may be rolled up to be attached to the upper portion of the rear surface of the ladder.

As an embodiment, referring to FIG. 20, an upper portion of the cover member may be coupled to an upper portion of the ladder.

A pole member 511 inserted into the sliding groove 110 of the horizontal frame 100 may be disposed on the upper portion 510 of the cover member. In particular, the pole member 511 of the cover member may be coupled to the sliding groove 110 installed in the horizontal frame 100 located at the uppermost end of the plurality of horizontal frames 100. In addition, the pole member 511 of the cover member may be inserted into and coupled to the sliding groove 100 installed at the upper end among the sliding grooves 110 installed above and below the horizontal frame 100 located at the uppermost end.

The upper sliding groove 110 of the horizontal frame 100 located at the uppermost end is not coupled to the pole member 410 of the step sheet 400. Therefore, the cover member 500 is coupled to the ladder through the upper sliding groove 110 of the uppermost horizontal frame 100 that is not coupled to the pole member 410 of the step sheet 400 to protect the ladder.

As used herein, the term “portion” includes a unit realized by hardware, a unit realized by software, and a unit realized using both sides. One unit may be realized using two or more hardware units, or two or more units may be realized using one hardware unit.

The protection scope of the present disclosure is not limited to the description and expression of the embodiments explicitly described above. It will be further added that the scope of protection of the present disclosure may not be limited due to obvious changes or substitutions in the technical field to which the present disclosure belongs.

1. A ladder comprising:
a pair of vertical frames;
a plurality of horizontal frames installed between the pair of vertical frames at predetermined intervals; and
a step sheet configured to be coupled to any two horizontal frames among the plurality of horizontal frames, respectively, to form a footrest of a ladder,
wherein the step sheet may be detachably coupled to the horizontal frame through a coupling means.

2. The ladder according to claim 1,
wherein the pair of vertical frames include a space therein, and is configured such that a plurality of hollow pipes having different diameters are continuously connected to each other, overlapped and stacked inside each other.

3. The ladder according to claim 1,
wherein the coupling means comprises a plurality of screws coupled through the horizontal frame and the step sheet.

4. The ladder according to claim 3,
wherein the coupling means further comprises a reinforcing plate installed between the head of the screw and the step sheet when the screw is coupled through the horizontal frame and the step sheet.

5. The ladder according to claim 1,
wherein the coupling means comprises a plurality of magnetic bodies coupled to each other by magnetism, and
wherein the plurality of magnetic bodies is disposed on one side of the horizontal frame and one side of the step sheet corresponding to the one side of the horizontal frame.

6. The ladder according to claim 1,
wherein the coupling means comprises:
a sliding groove formed on one side of the horizontal frame; and
a pole member formed on one side of the step sheet and coupled by sliding in the sliding groove.

7. The ladder according claim 6,
wherein a plurality of magnetic bodies coupled to each other by magnetism are provided at predetermined positions of the sliding groove and the pole member.

8. The ladder according claim 7,
wherein each of the magnetic bodies is disposed at both ends of the sliding groove and at both ends of the pole member, respectively, to prevent the pole member from being separated after the pole member is coupled to the sliding groove.

9. The ladder according claim 6,
wherein a plurality of magnetic bodies having different polarities are installed inside the sliding groove,
wherein each of the magnetic bodies having a first polarity is provided at both ends of the sliding groove, respectively,
wherein a plurality of magnetic bodies having a second polarity different from the first polarity are disposed between the magnetic bodies having the first polarity, and wherein each of the magnetic bodies having the second polarity is disposed at both ends of the pole member, respectively, and
when the pole member is coupled by sliding in the sliding groove, a magnetic body having a second polarity of the sliding groove and a magnetic body having a second polarity of the pole member exert repulsive force on each other in the sliding groove, thereby improving mobility of the pole member, and
at both ends of the sliding groove, a magnetic body having a first polarity of the sliding groove and a magnetic body having a second polarity of the pole member exert an attractive force on each other to prevent the pole member from being separated from each other.

10. The ladder according to claim 1,
wherein the coupling means comprises:
a sliding groove formed in an upper portion and a lower portion of the horizontal frame, respectively; and
a plurality of coupling members formed on both sides of the step sheet and coupled by sliding in the sliding groove, and
wherein the coupling member comprises:
a fixing hole inserted into the sliding groove through both ends of the sliding groove and configured to slide and move along the sliding groove;
a coupling hole coupled to one side of the step sheet; and
a connecting hole connecting the fixing hole and the coupling hole.

11. The ladder according to claim 9,
wherein a plurality of magnetic bodies having magnetism are provided at a predetermined position inside the sliding groove,
wherein the fixing hole is provided with a magnetic body coupled each other by magnetism to the magnetic body installed in the sliding groove, thereby when the fixing hole is positioned at a predetermined position where the magnetic body of the sliding groove is installed, being prevented from being separated by magnetism.
